(19) United States
(12) Patent Application Publication
(10) Pub. No.: US 2014/0168836 A1
(43) Pub. Date: Jun. 19, 2014

(54) ARRANGEMENTS FOR NETWORK PROTECTION

(71) Applicant: HEXATRONIC SCANDINAVIA AB, Hising Backa (SE)

(72) Inventor: Hans Grönqvist, Ljungskile (SE)

(73) Assignee: Hexatronic Scandinavia AB, Hisings Backa (SE)

(21) Appl. No.: 14/122,303

(22) PCT Filed: Apr. 25, 2012
(86) PCT No.: PCT/SE2012/050436

§ 371 Date: Feb. 11, 2014

(30) Foreign Application Priority Data
May 31, 2011 (SE) 1150512-0

(51) Int. Cl. H02H 3/10; H02H 9/00; H02H 3/46

(52) U.S. Cl. CPC H02H 3/10; H02H 3/46; H02H 9/00
USPC 361/79

(57) ABSTRACT

This disclosure relates an arrangement for protecting an electricity network against disturbances caused by for instance switched power techniques. By providing a filter, disturbances as generated in an interior network are attenuated by the filter and fed to an electrical inlet.

### TECHNICAL FIELD

This disclosure pertains in general to the field of electrical disturbances, and more particularly to devices for protection against electrical disturbances.

### BACKGROUND

Electrical appliances adapted to be connected to wall sockets have increased in numbers during recent years. As more and more functions and services require electricity to work, the number of electrical appliances or gadgets has increased.

Many kinds of appliances are now connected, some of which are sensitive devices. These devices risk to be damaged by electrical disturbances or other undesired signals that are present in the electricity network.

Sensitive equipment may therefore comprise filtering means such as a filter, which attenuates electrical disturbances and/or other undesired signals and therefore hinders these disturbances and signals from reaching sensitive equipment, or at least reduces the effect of said disturbances and signals.

It is known that said electrical disturbances or other undesired signals that are present in the electricity network can disturb electricity meters, causing erroneous meter readings.

Moreover, lightning protectors are available. One example of a lightning protector is an Uninterruptable Power Supply (UPS). A number of different UPS devices are available on the consumer market. The function of UPS devices is to maintain the power level during a shorter period of time in case of a power failure, in order to enable a controlled shut down of appliances and devices connected to said UPS devices. In addition, UPS devices may protect devices or appliances connected to the UPS against network disturbances in the form of electrical pulses caused by lightning.

DE 20319644 discloses a circuit for high frequency decoupling of electric consumer appliances from a voltage supply network with Power Line Communications (PLC) and broadband adaptors, preventing interference for broadband signal transmission over voltage supply network.

From WO01/10023 A1 a filter circuit is known for connection between a mains supply line and a load powered by the mains, where the filter circuit reduces radio frequency conducted emissions created by the load, where the radio frequencies are typically within the range from 1 kHz to 200 kHz.

As many different kinds of devices and appliances will be connected to the electricity network in the foreseeable future, there is a demand for various approaches for protection against electric disturbances.

### SUMMARY

An object of the present disclosure is to protect an electricity network against disturbances.

According to one aspect of this disclosure, a wall socket for protecting an electricity network against a wire restricted electrical disturbance, is provided. The wall socket comprises filtering means, an electrical outlet, and an electrical inlet, wherein the electrical inlet is configured to be connected to the electricity network, and wherein the filtering means is configured to attenuate an electrical signal obtained from the electrical outlet and to provide the attenuated electrical signal to the electrical inlet.

According to another aspect of this disclosure, a lamp socket for protecting an electricity network against a wire restricted electrical disturbance, is provided. The lamp socket comprises filtering means, an electrical outlet, and an electrical inlet, wherein the electrical inlet is configured to be connected to the electricity network, and wherein the filtering means is configured to attenuate an electrical signal obtained from the electrical outlet and to provide the attenuated electrical signal to the electrical inlet.

According to yet another aspect of the present disclosure, an electrical breaker for protecting an electricity network against a wire restricted electrical disturbance, is provided. The electrical breaker comprises filtering means, a circuit breaker, an electrical outlet, and an electrical inlet, wherein the electrical inlet is configured to be connected to the electricity network. The circuit breaker is configured to close or break an electrical connection between the electrical inlet and the electrical outlet, via the filtering means. The filtering means is configured to attenuate an electrical signal obtained from the electrical outlet and to provide the attenuated electrical signal to the electrical inlet.

According to still yet another aspect of the present disclosure, a fuse-box related device for protecting an electricity network against a wire restricted electrical disturbance, is provided. The fuse-box related device comprises filtering means, an electrical outlet, and an electrical inlet, wherein the electrical inlet is configured to be connected to the electricity network. The filtering means is configured to attenuate an electrical signal obtained from the electrical outlet and to provide the attenuated electrical signal to the electrical inlet.

Embodiments of the present disclosure provides the advantage that the power supplying network is protected from disturbances generated by appliances connected to said power supplying network.

An advantage with embodiments of the present invention is that a filtering means is comprised within a wall socket, a lamp socket, an electrical breaker device or a fuse box-related device. The filtering means is hence built-in into said sockets or devices, providing sockets and devices in which the filtering means is protected against wear and tear, and by which space can be saved by using a combined device/socket and filtering means.

Another advantage with embodiments of the present disclosure is that electricity meters now are able to correctly measure the electricity consumption.

### BRIEF DESCRIPTION OF DRAWINGS

These and other aspects, features and advantages of which this disclosure is capable of, will be apparent and elucidated from the following description of embodiments of this disclosure, reference being made to the accompanying drawings, in which

FIG. 1 schematically illustrates an electric configuration related to the present disclosure;

FIG. 2 schematically illustrates a general electrical socket according to embodiments of the present disclosure;

FIG. 3 schematically illustrates a mains switch according to embodiments of the present disclosure; and

FIG. 4 schematically illustrates a fuse-box related device according to embodiments of the present disclosure.

### ABBREVIATIONS

AC Alternating Current

EMC Electro Magnetic Compatibility

UPS Uninterruptable Power Supply

### DETAILED DESCRIPTION

It has recently been noticed that electricity meters in households have not been able to correctly measure the energy consumption. It has been suggested that this could be due to disturbances and undesired signals affecting the electricity meter.

It has long been known that devices and appliances that are connected to main sockets, lamp sockets or outlets, generate electrical disturbances to the electricity network. Acceptable levels of wire restricted disturbances are a part of the Electro Magnetic Compatibility (EMC) directive of the European Parliament and the European Council.

Wire restricted disturbances increase as a consequence of the increased number of devices and appliances that are connected to the electricity network.

A certain kind of disturbances that causes annoyance and problems is low-frequency wire restricted disturbances in the frequency interval from few kHz to a few hundreds of kHz.

It should be understood that disturbances to the network may also negatively affect other electrical installations than electricity meters. The electricity meter is hence one example of devices that are disturbed.

As energy in the form of electricity has become more expensive, various demands to reduce the power consumption of electrical appliances have been laid upon the manufacturers of consumer goods. For instance, adaptors transforming mains current to lower levels, by using switched techniques of modulating the pulse width, are now being used. These switched mains adaptors are nowadays available in a variety of products such as low energy lights, chargers of mobile phones, power supplies to TV-sets and computers etc.

The fundamental frequency of switches used is typically about 50-150 kHz.

It has also been found that the switching techniques do generate disturbances and undesired signals. These disturbances and undesired signals affect the electric environment negatively and may cause damages to sensitive equipments, in addition to causing electricity meters to present erroneous electricity consumptions.

Whereas the EMC-directive regulates wire restricted disturbances from 150 kHz and above, it does not regulate wire restricted disturbances having a frequency lower than 150 kHz.

Wire restricted disturbances do thus also increase as a consequence of novel demands on the energy efficiency laid upon the producers of devices and appliances.

The gist of the present disclosure is to protect the electricity network against such disturbances that originate from appliances connected to electricity networks.

By providing attenuating means in mains sockets, lamp outlets for instance, the network itself is efficiently protected against said electrical disturbances.

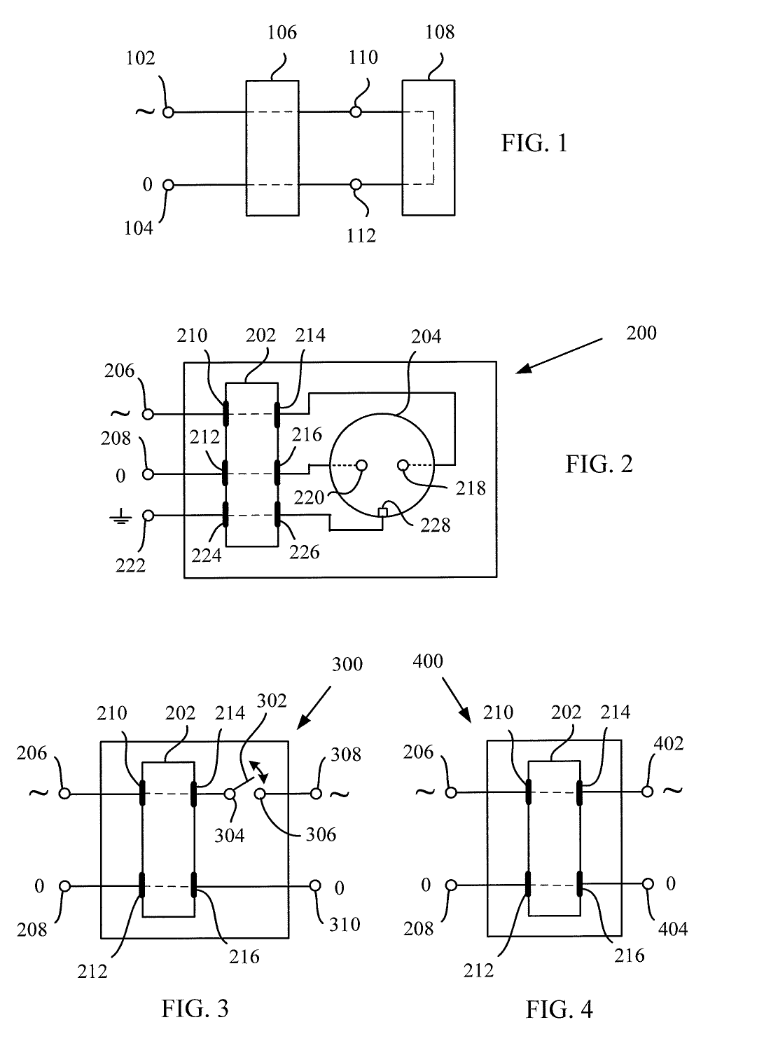

Reference is now made to FIG. 1, which schematically illustrates an electric configuration related to the present disclosure.

FIG. 1 comprises a mains power line 102, a neutral line 104, filtering means 106 and an appliance 108. The appliance 108 is connected to the filtering means 106 via a mains connector 110 and a neutral connector 112. The filtering means is connected to a network providing electric power via the mains power line 102 and the neutral line 104. The filtering means may be regarded to be connected in parallel with the mains power line 102 and the mains connector 110, as well as in parallel with the neutral line 104 and the neutral connector 112.

The appliance 108 represents appliances that generate electric disturbances and/or electric signals or spikes that are undesired by the network.

By connecting a filtering means between the disturbance generating appliance 108 and the electric power, disturbances and/or electric signals or spikes that are undesired by the network are subjected to filtering by the said filtering means 106. By attenuating said disturbances by the filtering means, the effect of these disturbances on the network is thus reduced.

By providing an efficient filtering means the effect on the network may therefore be vastly reduced.

It is noted that it is an advantage to apply filtering means near or close to the disturbance generating source, since this hinders further spreading of the disturbances. It is thus an advantage to apply filtering means closer to, rather than further away from said disturbance generating source.

By providing filtering means between the appliance and the network that feeds the appliance with electric power, the effect of the disturbances is efficiently reduced.

Referring to FIGS. 2-4 electricity network devices are presented in which filtering means are provided to protect the electricity network from disturbances and undesired signals such as spikes and so on.

FIG. 2 schematically presents a generalized electrical socket 200 such as a wall socket or a lamp socket. The generalized electrical socket 200 comprises filtering means 202 and an explicit electrical outlet 204.

The electrical outlet 204 typically comprises a recession to which a mating male plug of an electric appliance can be connected. The recession may be considered to be a female contact to which the male plug may be fitted.

Electric power may be fed from a network and provided between a mains power connector 206 and a neutral connector 208. The mains power connector 206 is connected to a first contact point 210 of the filtering means 202. The neutral connector 208 is connected to a second contact point 212 of the filtering means 202. It is noted that the first and second contact points of the filtering means are provided on one side of the filtering means 202 which may be called the network side, since the mains power is provided to said filtering means from this side.

Via the filtering means 202 the mains power is provided from the first contact point 210 to a third contact point 214 that is positioned on said filtering means 202 on an appliance side of said filtering means. The appliance side refers to the side onto which an appliance may be connected.

Via the neutral connector 212 and the filtering means 202 a neutral potential is provided to a fourth contact point 216.

Electric power is hence provided to the electrical outlet 204. The third contact point 214 then feeds mains power to a first contact 218 of the electrical outlet 204. The fourth contact point 216 is connected to a second contact 220, which second contact 220 is comprised within the electrical outlet 204.

It has thus been explained how mains power may be provided to an electrical outlet 204 of a generalized mains socket 200.

A mentioned above the electrical outlet 204 is configured to mate male plugs from appliances such as lights, adaptors, power converters and the like.

Due to higher demands on reduced energy consumption per connected item, the switching technique has gained popularity as mentioned above. Also the switching technique generates disturbances and/or undesired signals, such as spikes or the like.

These disturbances are typically fed to the electric outlet 204 via the first 218 and the second 220 contact of the electrical outlet 204, when an AC adaptor or the like is connected to a generalized main socket 200 according to embodiments of the present disclosure.

The electrical outlet 204 thus receives disturbances from for instance an AC adaptor being one kind of appliance. Via the first 218 and the second 220 contacts of the electrical outlet 204, disturbances generated by an appliance connected to said electrical outlet 204 are thus fed to the appliance side of the filtering means 202. The disturbances are provided between the third 214 and fourth 216 contact points of the filtering means 202.

It must now be underlined that the filtering means may be adapted to attenuate frequencies in the range from about 2 kHz to about 1.5 MHz. According to an alternative embodiment the filtering means within the generalized mains socket is adapted to attenuate frequencies in the range from about 10 kHz to about 1 MHz.

According to yet an alternative embodiment the filtering means within the generalized mains socket is adapted to attenuate frequencies in the range from about 50 kHz to about 150 kHz

The filtering means may thus also attenuate frequencies over 150 kHz. Wire resident disturbances having a frequency above 150 kHz are however regulated in the EMC directive, for which reason such frequencies might already be taken care of elsewhere, or designed around in order to avoid.

The filtering means may be realized in a plurality of different ways. These are well known to the artisan for which reason these are not further discussed here. For instance, the filtering means may be implemented by using passive components.

By for instance using a generalized mains socket 200 having filtering means, a wall socket may be realized to which a disturbance generating appliance may be connected via the electrical outlet 204, without the risk to forward harmful wire restricted disturbances to the network. Since the filtering means attenuates the disturbances by reducing the amplitude of the frequencies thereof, the resulting amplitude of the disturbances is typically much reduced by said filtering means 202. The mains power connector 206 as well as the neutral connector 208 will thus not be reached by disturbing frequencies having harmful amplitudes.

To attenuate frequencies herein is meant to attenuate frequencies so that the attenuated frequencies do not disturb the electricity network to which the generalized mains socket 200 is connected. Such attenuation can be about 10 or 15 dB, or higher. The higher dB, the better attenuation of frequencies subjected to said attenuation. Attenuation higher than 10 or 15 dB, for instance 20 dB, is hence also envisaged in embodiments of the present invention.

It is emphasized that a clear advantage is provided by the present disclosure. By providing a generalized wall socket or light socket according to this disclosure, an electricity meter positioned on the network side of the filtering means will not be negatively affected by disturbing frequencies. This means that said electricity meter will now be able to corrected measure the energy consumption of the appliances or gadgets connected to the electrical outlet 204 of the wall socket 200.

It should be clarified that the generalized mains socket 200 may as well be a light socket or bulb socket to which a light or bulb is directly connected via the electrical outlet 204.

Also, the description above has presented unearthed mains power. As mains power often is provided with an additional earth potential, FIG. 2 will further be described below.

The mains socket 200 may be provided with or without connectors for earth potential.

According to some embodiments of the present disclosure an earth connector 222 is comprised by the mains socket 200. The earth connector 222 is connected to fifth contact point 224 of the filtering means 202, on the network side of said filtering means 202. On an appliance side of the filtering means 202, a sixth contact point 226 is provided to which the fifth contact point of the filtering means 202 is connected. From the sixth contact point 226 earth potential is further fed to a third contact 228 of the electrical outlet 204. Thus, by providing an earth connector 222 to the mains socket 200, earth potential may be provided to the electrical outlet 204 of the mains socket 200. Needless to say the earth connector 222 must be connected to earth potential, preferably from the network.

Above, a mains socket 200 has been described. Down below, other arrangements according to embodiments of the present disclosure are presented.

FIG. 3 schematically presents a mains breaker comprising filtering means 202. The function of the filtering means 202 is similar to or the same as the function of the filtering means 202 as presented in FIG. 2 and as described above. Reference is hence made to FIG. 2 and the accompanying text for parts also comprised in FIG. 3.

It is noted that the filtering means in FIG. 2 comprises a connector 222 for earth potential, whereas the filtering means 202 of FIG. 3 does not. Although FIG. 3 does not present a connector for earth potential, the mains breaker 300 may be provided with a connector for earth potential and earth contact points of the filtering means as well as an earth connector on the appliance side of the filtering means.

Now, the mains breaker 300 also comprises an explicit circuit breaker 302 provided between a first contact point 304 of the circuit breaker 302 and a second contact point 306 of the circuit breaker 302. It is the circuit breaker 302 that renders the function of the mains breaker 300. By opening and closing the circuit breaker 302 the electric connection between the third contact point 214 and a first connector 308 of the appliance side, is broken and established, respectively. FIG. 3 also presents a connection between the fourth contact point 216 of the filtering means 202 and a second connector 310 on the appliance side of the mains breaker.

Thus, a disturbance generating appliance such as a lamp, an AC adaptor, a power converter and the like may thus be connected between the first 308 and the second 310 connectors of the mains breaker, without risking said disturbances to reach the network side of the filtering means 202.

In FIG. 3, the network may provide mains power to mains power connector 206 and a neutral line to the neutral connector 208.

FIG. 4 schematically presents a fuse box plug-in device 400 comprising a filtering means 202.

It must be mentioned that the function of items enumerated 206-216 is similar to or the same as the one described above in relation to FIGS. 2 and 3.

It is however added that the mains power connector 206 is configured to be connected to mains power from the network. This mains power has typically already passed an electricity meter attempting to determine the electricity consumption of a household. The neutral connector 208 is configured to be connected to an incoming neutral line from the network.

The fuse box plug-in device further comprises a first 402 and a second 404 connector on the interior network side, which connectors are configured to be connected to interior network contact points of a fuse box. The fuse box plug-in device is thus configured to be directly connected to mains power inlet of a fuse box by the mains power connector 206 and the neutral connector 208, and is therefore configured to stand levels of current that typically are higher than the ones needed in a mains socket or a main breaker, at least for households.

Even though the fuse box plug-in device of FIG. 4 does is not schematically illustrated with a connector for earth potential, the fuse box plug-in device 400 may be provided with a connector for earth potential on each side of the filtering means 202. A connector may thus be provided on a side directed towards a mains power distributor and one connector may be provided on the side facing an interior network of, for instance, residential properties such as households or other buildings. Fuse box plug-in devices may accordingly also be equipped with earth connectors.

It is clarified that an earth connector is here defined to be connected to earth potential.

The function of the filtering means 202 herein is however similar to the one of the filtering means are described above in relation to FIGS. 2 and 3. The function of the filtering means of FIG. 4 is to prevent disturbances to be distributed to an external electricity network to which the fuse box is connected and which network feeds the fuse box with electricity.

This is realized by connecting a first 402 and a second 404 connector of the interior network side to said disturbance generating interior network.

Since an electricity meter typically is connected on the network side of a fuse box, the electricity meter will thus not be negatively affected and may therefore correctly determine the consumption of electricity.

In addition to the technical features and subject-matter as discussed above and explicitly illustrated, the present disclosure also comprises embodiments in which said features and subject-matter also comprise one or more connectors for earth potential.

Some advantages of the present disclosure are the following:

Embodiments of the present disclosure provides the advantage that the power supplying network is protected from disturbances generated by appliances connected to said power supplying network.

Another advantage with embodiments of the present disclosure is that electricity meters connected according to the present disclosure are now able to correctly determine the consumed amount of electricity.

It must be emphasized that this disclosure may be varied in many ways.

It has to be added that this disclosure also comprises embodiments in which more than one mains power phase is being used. As the function for each one of a multiple phases is the same as for a single phase, the present disclosure presenting a description for one phase is considered to also comprise the usage of more than a single phase.

The elements of an embodiment of this disclosure may be physically, functionally and logically implemented in any suitable way. Indeed, the functionality may be implemented in a single unit, in a plurality of units or as part of other functional units. As such, this disclosure may be implemented in a single unit, or may be physically and functionally distributed between different units and processors.

It is made clear that presented embodiments may well be combined forming new embodiments not explicitly described herein.

In the claims, the term “comprises/comprising” does not exclude the presence of other elements or steps. Additionally, although individual features may be included in separate claims, these may be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

Although this disclosure has been described above with reference to (a) specific embodiment(s), it is not intended to be limited to the specific form set forth herein. Rather, this disclosure is limited only by the accompanying claims and, other embodiments than the specific above are equally possible within the scope of these appended claims.

1. A wall socket for protecting an electricity network against a wire restricted electrical disturbance, the wall socket comprising:
a filter;
an electrical outlet; and
electrical inlet, wherein the electrical inlet is configured to be connected to the electricity network, and wherein the filter is configured to attenuate an electrical signal obtained from the electrical outlet and to provide the attenuated electrical signal to the electrical inlet.

2. The wall socket of claim 1, wherein the filter further is configured to attenuate an electrical signal having a frequency in the range from 2 kHz to 1.5 MHz.

3. The wall socket of claim 1, wherein the filter further is configured to attenuate an electrical signal having a frequency in the range from 10 kHz to 1 MHz.

4. The wall socket of claim 1, wherein the filter further is configured to attenuate an electrical signal having a frequency in the range from 50 kHz to 150 kHz.

5. A lamp socket for protecting an electricity network against a wire restricted electrical disturbance, the lamp socket comprising:
a filter;
an electrical outlet; and
an electrical inlet, wherein the electrical inlet is configured to be connected to the electricity network, and wherein the filter is configured to attenuate an electrical signal obtained from the electrical outlet and to provide the attenuated electrical signal to the electrical inlet.

6. An electrical breaker device for protecting an electricity network against a wire restricted electrical disturbance, the electrical breaker device comprising:
a filter:
a circuit breaker;
an electrical outlet; and
an electrical inlet, wherein the electrical inlet is configured to be connected to the electricity network, wherein the circuit breaker is configured to close or break an electric connection between the electrical inlet- and the electrical outlet via the filter, and wherein the filter is configured to attenuate an electrical signal obtained from the electrical outlet and to provide the attenuated electrical signal to the electrical inlet.

7. A fuse-box related device for protecting an electricity network against a wire restricted electrical disturbance, the fuse-box related device comprising:
a filter;
an electrical outlet; and
an electrical inlet, wherein the electrical inlet is configured to be connected to the electricity network, and wherein the filter is configured to attenuate an electrical signal obtained from the electrical outlet and to provide the attenuated electrical signal to the electrical inlet.
